(19) United States
(12) Patent Application Publication
(10) Pub. No.: US 2021/0241206 A1
(43) Pub. Date: Aug. 5, 2021

(54) WORK PROCESSING APPARATUS AND METHOD THEREOF

(71) Applicants: Jae Ho Choi, Seoul (KR); Delta PDS Co., Ltd., Seoul (KR)

(72) Inventor: Jae Ho CHOI, Seoul (KR)

(73) Assignees: Delta PDS Co., Ltd., Seoul (KR); Jae Ho Choi, Seoul (KR)

(21) Appl. No.: 17/122,248

(22) Filed: Dec. 15, 2020

(30) Foreign Application Priority Data
Jan. 31, 2020 (KR) 10-2020-0011514

(51) Int. Cl. G06Q 10/06; G06Q 10/10; G06Q 50/00; H04L 12/58

(52) U.S. Cl. CPC G06Q 10/063118; H04L 51/32; G06Q 50/01; G06Q 10/1097

(57) ABSTRACT

A work processing apparatus showing one or more tasks, including a memory and a processor. The processor is configured to involve one or more users; include information about one or both of a start date and a deadline of a work schedule; generate a recursive work processing object including specifics of the one or more tasks to be executed within the work schedule according to a request of a work generator; designate a first user out of the users as a person in charge of the recursive work processing object according to designation by the work generator; if the one task processed by the first user as the person in charge is completed, change a second user out of the users designated to undertake another task as the person in charge; and store information about the person in charge for each task in the recursive work processing object.

### CROSS-REFERENCE TO PRIOR APPLICATION

This application claims priority to Korean Patent Application No. 10-2020-0011514 (filed on Jan. 31, 2020), which is hereby incorporated by reference in its entirety.

### BACKGROUND

The present disclosure relates to a work processing technology and, more particularly, to a work processing system in which two or more users forming a group of work participants undertake and process specific tasks.

The present disclosure relates to a technology for processing a work involving two or more persons in charge and, more particularly, to a work processing system providing a work processing function for each person in charge, a function for checking a work, and a function for changing persons in charge.

Also, the present disclosure relates to a technology for providing a work processing system in which persons in charge may be changed according to the progress of sub-works.

The Korea registered patent No. 10-1263590 (May 13, 2013) discloses a total business supporting system 100 supporting multi-browsing.

The Korea patent application publication No. 10-2012-0007302 (Jan. 20, 2012) discloses a business management system capable of providing work processing status for each person in a form of computerized information.

### SUMMARY

According to one embodiment of the present disclosure, when a person in charge of a sub-work is changed, a notification or a message about the corresponding sub-work is provided to a relevant user designated as a person in charge in a current assignment.

According to an embodiment of the present disclosure, a work processing method and apparatus are provided, which provide a user communication channel dedicated to the corresponding recursive work processing object.

Among embodiments, in a work processing apparatus showing one or more tasks and including a memory and a processor connected electrically to the memory, the processor being configured to involve one or more users; include information about one or both of a start date and a deadline of a work schedule; generate a recursive work processing object including specifics of the one or more tasks to be executed within the work schedule according to a request of a work generator; designate a first user out of the users as a person in charge of the recursive work processing object according to designation by the work generator; if the one task processed by the first user as the person in charge is completed, change a second user out of the users designated to undertake another task as the person in charge; and store information about the person in charge for each task in the recursive work processing object.

Also, among embodiments, in a work processing method showing one or more tasks and being performed by a memory and a processor connected electrically to the memory, the work processing method comprises involving one or more users; including information about a start date and a deadline of a work schedule; generating the recursive work processing object including specifics of the one or more tasks to be executed within the work schedule according to a request of a work generator; designating a first user out of the users as a person in charge of the recursive work processing object according to designation by the work generator; if the task processed by the first user is completed, changing a second user designated out of the users as the person in charge; and storing information about the person in charge for each task in the recursive work processing object.

### BRIEF DESCRIPTION OF THE DRAWINGS

FIG. 1 illustrates a work processing system according to one embodiment of the present disclosure.

FIG. 2 illustrates a block diagram of a work processing system according to one embodiment of the present disclosure.

FIG. 3 illustrates a block diagram of a processor within a work processing system according to one embodiment of the present disclosure.

FIG. 4 is a flow chart illustrating a work processing method according to one embodiment of the present disclosure.

FIG. 5 is a signal flow diagram illustrating a work processing method according to another embodiment of the present disclosure.

FIG. 6 is a signal flow diagram illustrating a work processing method according to yet another embodiment of the present disclosure.

FIGS. 7 and 8 illustrate a recursive work processing object provided through a chat room according to an embodiment of the present disclosure.

### DETAILED DESCRIPTION

Since description of the present disclosure is merely an embodiment for illustrating structural or functional description, it should not be interpreted that the technical scope of the present disclosure is limited by the embodiments described in this document. In other words, embodiments may be modified in various ways and implemented in various other forms; therefore, it should be understood that various equivalents realizing technical principles of the present disclosure belong to the technical scope of the present disclosure. Also, since it is not meant that a specific embodiment should support all of the purposes or effects intended by the present disclosure or include only the purposes or effects, the technical scope of the present disclosure should be not regarded as being limited to the descriptions of the embodiment.

Meanwhile, implication of the terms used in this document should be understood as follows.

The terms such as “first” and “second” are introduced to distinguish one element from the others, and thus the technical scope of the present disclosure should not be limited by those terms. For example, a first element may be called a second element, and similarly, the second element may be called the first element.

If a constituting element is said to be “connected” to other constituting element, the former may be connected to the other element directly, but it should be understood that another constituting element may be present between the two elements. On the other hand, if a constituting element is said to be “directly connected” to other constituting element, it should be understood that there is no other constituting element present between the two elements. Meanwhile, other expressions describing a relationship between constituting elements, namely “between” and “right between” or “adjacent to” and “directly adjacent to” should be interpreted to provide the same implication.

A singular expression should be understood to indicate a plural expression unless otherwise explicitly stated. The term “include” or “have” is used to indicate existence of an embodied feature, number, step, operation, constituting element, component, or a combination thereof; and should not be understood to preclude the existence or possibility of adding one or more other features, numbers, steps, operations, constituting elements, components, or a combination thereof.

Identification symbols (for example, a, b, and c) for individual steps are used for the convenience of description. The identification symbols are not intended to describe an operation order of the steps. Therefore, unless otherwise explicitly indicated in the context of description, the steps may be executed differently from the stated order. In other words, the respective steps may be performed in the same order as stated in the description, actually performed simultaneously, or performed in a reverse order.

The present disclosure may be implemented in the form of program codes in a computer-readable recording medium, where a computer-readable recording medium includes all kinds of recording apparatus which store data that may be read by a computer system. Examples of a computer-readable recording medium include a ROM, a RAM, a CD-ROM, a magnetic tape, a floppy disk, and an optical data storage device. Also, the computer-readable recording medium may be distributed over computer systems connected to each other through a network so that computer-readable codes may be stored and executed in a distributed manner.

Unless defined otherwise, all of the terms used in this document provide the same meaning as understood generally by those skilled in the art to which the present disclosure belongs. Those terms defined in ordinary dictionaries should be interpreted to have the same meaning as conveyed by a related technology in the context. And unless otherwise defined explicitly in the present disclosure, those terms should not be interpreted to have ideal or excessively formal meaning.

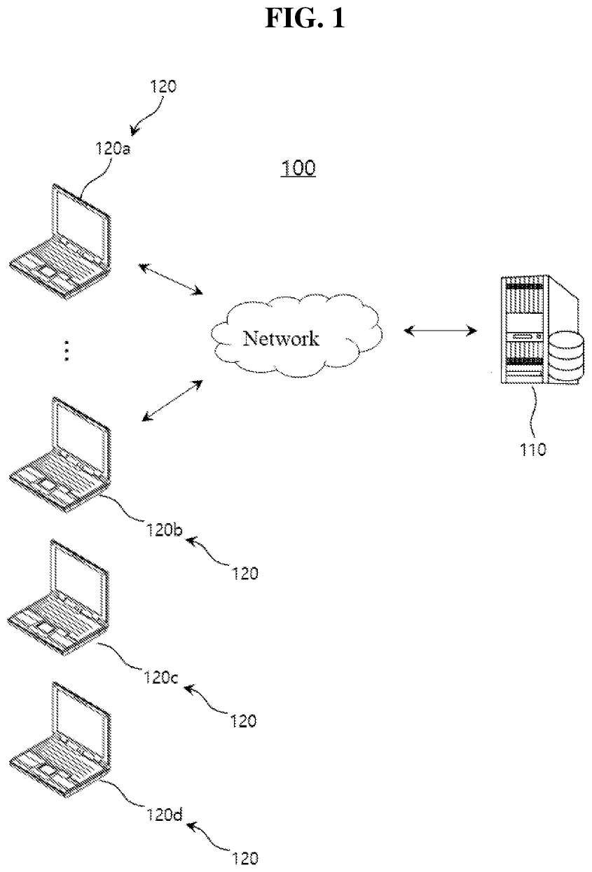

FIG. 1 illustrates a work processing system 100 according to one embodiment of the present disclosure.

Referring to FIG. 1, a work processing system 100 includes a work processing apparatus 110 and one or more user terminals 120.

The work processing apparatus 110 includes a memory and a processor connected electrically to the corresponding memory, which corresponds to a computing device that may be connected to at least one user terminal 120 through a network. In one embodiment, the work processing apparatus 110 may manage at least one member group including users associated with the user terminals 120 as members.

Here, the users may include one or more work generators, persons in charge of one or more sub-works, namely, tasks, included in one work, and other users. In an embodiment of the present disclosure, all of the work generators, persons in charge, and users associated with the corresponding work or having access rights thereto may be collectively referred to as work participants.

In other words, the work generator corresponding to the work generator terminal 120a, persons in charge corresponding to the person-in-charge terminals 120b, 120c, and other users may be work participants who assign, receive, or execute a work by accessing the work processing apparatus 110 jointly or simultaneously. Also, during this process, when someone among the work participants shares a file in a shared folder, the work participants may access the shared file in the shared folder within their rights allowed for them.

And the user terminals 120 may include a work generator terminal 120a, which is a user terminal of the work generator, person-in-charge terminals 120b, 120c, which are user terminals of the persons in charge, and user terminals 120d of other users or work associates.

In one embodiment, the work processing apparatus 110 may be connected to the user terminal 120 through a shared folder agent installed in the user terminal 120, where the shared folder agent corresponds to an agent program, which is software being installed in the user terminal 120 and supporting the user terminal 120 to be interoperable with the work processing apparatus 110 under an approval of the user terminal 120.

The user terminal 120 may correspond to a computing device connected to the work processing apparatus 110 through a network, which may be a user terminal implemented in the form of a desktop, a notebook, a tablet PC, or a smartphone.

In one embodiment, the work generator terminal 120a may be a mobile terminal and may be connected to the work processing apparatus 110 through cellular communication or WiFi communication. In another one embodiment, the work processor terminal 120b, 120c may be a desktop or a laptop computer and may be connected to the work processing apparatus 110 through the Internet.

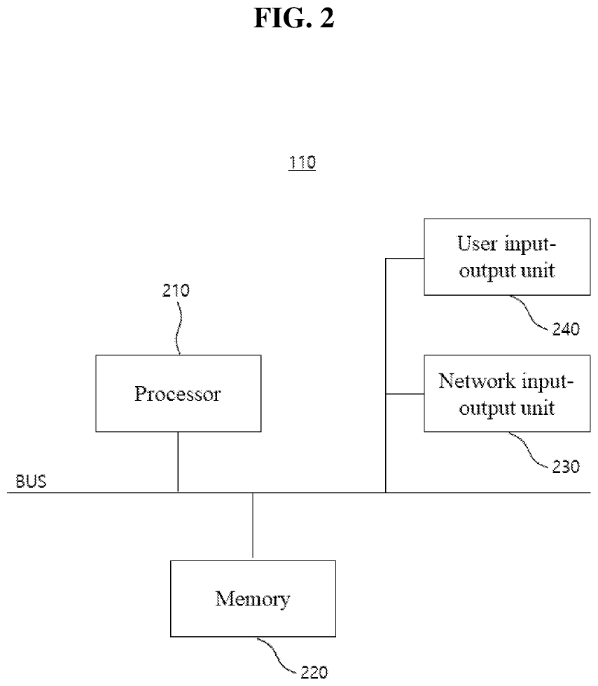

FIG. 2 illustrates a block diagram of a work processing system 110 according to one embodiment of the present disclosure.

Referring to FIG. 2, the work processing apparatus 110 may include a processor 210, a memory 220, a user input-output unit 230, and a network input-output unit 240.

The processor 210 may execute a recursive work processing procedure according to an embodiment of the present disclosure, manage the memory 220 read or written during the procedure, and schedule a synchronization timing between a volatile memory and a non-volatile memory of the memory 220.

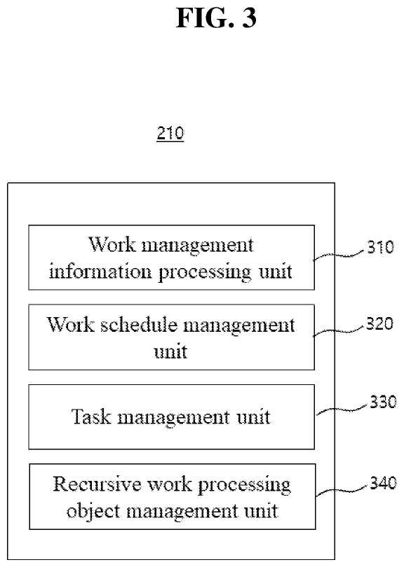

The processor 210 may control the overall operations of the work processing apparatus 110 and by being connected electrically to the memory 220, the user input-output unit 230, and the network input-output unit 240, control a data flow among them. The processor 210 may be implemented by the Central Processing Unit (CPU) of the work processing apparatus 110. More specific operations of the processor 210 will be described in detail with reference to FIG. 3.

The memory 220 may include an auxiliary memory device implemented using non-volatile memories such as Solid State Disk (SSD) or Hard Disk Drive (HDD) and used for storing all of the data required for the work processing apparatus 110 and may include a main memory device implemented using volatile memories such as Random Access Memory (RAM). As described above, the memory 220 may be implemented by using volatile or non-volatile memories, and when non-volatile memories are used, they may be installed so as to be connected to each other through a hyperlink.

The user input-output unit 230 includes an environment for entering or receiving various user signals and an environment for outputting a specific signal or information to the user. For example, the user input-output unit 230 may include an input device that includes an adaptor, such as a mouse, a trackball, a graphic tablet, a scanner, a touch screen, a keyboard, or a pointing device; and an output device that includes an adaptor, such as a monitor or a touch screen.

In one embodiment, the user input-output device 230 may correspond to a computing device accessed through remote access and in that case, the work processing apparatus 110 may perform the role of a server.

The network input-output unit 240 includes an environment for connecting to the user terminal 120 through a network. For example, the network input-output unit 240 may include an adaptor for Local Area Network (LAN) communication. When a user signal is received through a communication network from the user terminal 120, the corresponding user signal may be entered to the work processing apparatus 110 through the network input-output unit 240.

FIG. 3 illustrates a block diagram of a processor 210 within a work processing system 110 according to one embodiment of the present disclosure.

The processor 210 of the work processing apparatus 110 according to an embodiment of the present disclosure may include a work management information processing unit 310, a work schedule generating unit 320, a task management unit 330, and a recursive work processing object management unit 340. However, it should be noted that the processor 210 according to an embodiment of the present disclosure does not necessarily have to include all of the units at the same time, but some of the units may be omitted depending on the respective embodiments, or the whole or part of the units may be included selectively.

First, the work management information processing unit 310 may receive and store information about users or user terminals 120 participating in a work and information related to work generation. And the work management information processing unit 310 may also store information about a work schedule or tasks to be done according to the work schedule.

And the work management information processing unit 310 may store user information about one or more users who may be designated as persons in charge and provide the user information when persons in charge are designated by the work generator or one or more users.

The user information managed by the work management information processing unit 310 may include information on specific details of the rights allowed for the respective users. In other words, users corresponding to work participants including persons in charge may have different rights for a work processing object and/or the respective tasks included in the object.

For example, depending on whether a user is designated as a person in charge or whether the user is involved in the recursive work processing object as a work participant even though the user may not be the person in charge, the rights for the corresponding user to access, retrieve, modify, or delete a task or the recursive work processing object may be determined. As one example, a user designated as a person in charge may have rights to modify, delete, or edit the corresponding task, but work participants other than the person in charge may be allowed to have only the rights to retrieve the corresponding task. Also, a user designated by the person in charge may be exceptionally allowed to have the rights to modify or edit the corresponding task.

And a user having rights for a recursive work processing object may have the same specifics of rights in a chat room created in association with the recursive work processing object.

The work scheduling generating unit 320 may generate a work schedule in response to a request of a work generator in the existence of the request from the work generator or according to a procedure preconfigured in association with generation of the work schedule. However, generation of a work schedule may be executed based on at least one information of a start date and/or a deadline of the work schedule together with the request of the work generator or configuration with respect to work generation described above. In other words, generation of a work schedule does not necessarily require that all of the start date and the deadline of the work schedule are confirmed in advance; rather, the work schedule may still be generated not only when both of the start date and the deadline of the work schedule are confirmed in advance but also when one or both of the two dates are temporarily undetermined.

And the work scheduling generating unit 320 may receive additional information about work specifics and a work period from the work generator terminal 120a to generate, modify, or update the work schedule.

The task management unit 330 may receive and store information about one or more tasks included in a work schedule. And the task management unit 330 may also receive and store information about persons in charge of the respective tasks.

The task management unit 330 may receive and store the name and specifics of a task to be done within a work schedule and information about a person in charge of the corresponding task; the task management unit 330 may also receive or generate the order of tasks to be processed and information about the deadline of the tasks.

Also, the task management unit 330 may calculate and store a list of persons in charge in the order of tasks and the order of designating persons in charge. Types, names, and specifics of tasks may be determined in advance or may be added, deleted, or modified later by an authorized user such as the work generator along with the progress of the work schedule.

For example, to process a work including three tasks to be done within a specific work schedule, the task management unit 330 may receive and store information about three tasks in advance, namely, a first task, a second task, and a third task. And the task management unit 330 may set a person in charge of the first task as a first user, a person in charge of the second task as a second user, and a person in charge of the third task as a third user.

Here, a person in charge may be designated in advance when a work generator generates a work schedule or may be designated later by the work generator according to the progress of a work schedule or processing status of tasks. Also, a person in charge may be designated by the work generator or by another authorized user. For example, a person in charge may be determined in a way that the next person in charge is designated by a current person in charge.

In this case, the work generator or the current person in charge may select or designate the next person in charge by considering specifics of the next task and work processing status of current work participants.

And the task management unit 330 may also determine in advance as to when and until when the first, second, and third tasks are to be processed. For example, the processing period of the first task may be set from Jan. 1, 2020 to Jan. 31, 2020; that of the second task from Feb. 1, 2020 to Feb. 28, 2020; and that of the third task from Mar. 1, 2020 to Mar. 31, 2020. In this case, for the period from Jan. 1, 2020 to Jan. 31, 2020, the first user is designated as a person in charge; for the period from Feb. 1, 2020 to Feb. 28, 2020, the second user is designated as a person in charge; and for the period from Mar. 1, 2020 to Mar. 31, 2020, the third user is designated as a person in charge.

Or, the processing period of a task may be set in various ways; for example, the processing period of the first task may be set from Jan. 1, 2020 to before Jan. 31, 2020; the processing period of the second task may be set from when the first task is completed to before Feb. 28, 2020; and the processing period of the third task may be set from when the second task is completed to before Mar. 31, 2020.

The recursive work processing object management unit 340 may generate a recursive work processing object encapsulated as one object including information of users included in the work participants, work schedule information, task information, information about persons in charge of the respective tasks, work deliverables corresponding to processing specifics of processed tasks and/or work instructions of tasks to be processed.

In other words, in an embodiment of the present disclosure, a recursive work processing object may be a kind of a work object encapsulated as one object including one or more tasks to be processed within a work schedule; and all of processing results of a work specified by the corresponding tasks, information about persons in charge of the corresponding tasks, information about approval of a person in charge with respect to the processing results of the tasks, and confirmation information. The result of work processing for each task, information about persons in charge of the corresponding tasks, and information about approval of a person in charge with respect to the processing results of the tasks, and confirmation information may be accumulated in the recursive work processing object in a temporal order.

According to start, progress, and completion of a task, two or more tasks may be processed sequentially within one recursive work processing object, a person in charge may be designated for each task, and a person in charge of the corresponding recursive work processing object may be changed according to the progress of the tasks. And, if a task is returned to the work generator who has generated an initial work schedule after the task is processed by two or more persons in charge, namely, after persons in charge of the task are designated in turn within a user group, the corresponding recursive work processing object may be terminated.

In one embodiment of the present disclosure, a work schedule may be generated, and two or more tasks to be processed within the corresponding work schedule may be generated. And a recursive work processing object including the corresponding tasks may be generated. As the work schedule is initiated, tasks may be processed sequentially or in succession, but persons in charge of the respective tasks may be designated differently. And as the persons in charge of the respective tasks are different from each other, persons in charge of a recursive work processing object may be changed sequentially or in succession. This is so because a person in charge of a task currently being processed is designated as a person in charge of the corresponding recursive work processing object.

A person in charge may refer to a user who directly processes the corresponding task or who instructs another user to process the task and proceeds, manages, and takes responsibility of a work until the corresponding task is completed.

As a work schedule is initiated, when a first task included in a recursive work processing object is initiated, proceeded, and completed, completion of the first task is confirmed by a method such as electronic approval by the corresponding person in charge of the first task, and as a second task to be processed next is initiated, the person in charge of the recursive work processing object is changed to a person in charge of the second task. It is obvious that when the persons in charge of the first and second tasks are the same, the person in charge of the recursive work processing object may not be changed.

As the second task is initiated, when the second task is proceeded and completed, completion of the second task is confirmed by a method such as electronic approval by the person in charge of the second task, and a third task may be initiated. And accordingly, the person in charge of the recursive work processing object is changed to a person in charge of the third task.

Here, a user interface for electronic approval of each task may be provided by the recursive work processing object. As described above, the recursive work processing object according to an embodiment of the present disclosure may include one or more tasks to be processed within a work schedule and may provide processing status of each task to work participants. Also, the recursive work processing object according to the present disclosure may provide a processing result of tasks processed sequentially, a processing schedule, a user interface for processing and confirming tasks, and a communication means among work participants such as a chat room.

Now, descriptions are given with respect to an example where tasks to be processed within a work schedule comprise three tasks of a first task, a second task, and a third task. In this case, a work generator may request generation of a recursive work processing object with respect to the corresponding work schedule. After the work schedule is initiated, a person in charge of the corresponding work processing object is designated as a first user while the first task is under progress. And the first task is processed until processing of a work corresponding to the specifics of the first task is completed.

And when the first task is completed, the second task is initiated, and as the second task is initiated, the person in charge of the corresponding recursive work processing apparatus may be changed to a second user. And when the second task is completed, the third task is initiated, and the person in charge of the recursive work processing apparatus is changed to a third user.

When the third task is also completed, the person in charge of the corresponding recursive work processing object is again changed to the work generator. As described above, when persons in charge are changed in turn within work participants including the work generator and the work generator again takes the role of a person in charge of a recursive work processing object, the corresponding recursive work processing object may be terminated.

Here, a person in charge of the last task may designate the next person in charge as the work generator. Or, the work processing apparatus 110 may be configured so that when a task processed by the person in charge of the last task is terminated, the next person in charge is automatically changed to the work generator.

As a work schedule is proceeded and tasks are processed, processing results of the tasks are accumulated, and persons in charge are also changed. Details of the update above may all be stored in the recursive work processing object.

In other words, specific instructions of the first task and processing results corresponding to the instructions, information about who is the first person in charge, update details for each task, describing that the person in charge is changed to the second user and then to the third user after the second and third tasks are initiated after the first task is completed, and information about persons in charge of the respective tasks are added to the recursive work processing object and encapsulated again to be processed as one object.

And when a recursive work processing object is transmitted within a chat room, the most recently updated version of the recursive work processing object may be transmitted based on the transmission time.

Here, the update may correspond to the specifics of each task and include adding, modifying, changing, and editing a file object shared through the recursive work processing object or adding another part of specifics to the task. Also, when there is a change in the person in charge of each task or in the work schedule, revising information about the person in charge or information about the work schedule by considering the change may also be included in the update.

Also, generating a new file object in addition to an existing file object and encapsulating the file objects; and generating a new file object and adding the generated file object to a folder object shared through the recursive work processing object may correspond to an update for adding a file object itself Also, adding, modifying, editing, revising, and supplementing the contents of a shared file object and/or a shared folder object and inserting a note to the contents thereof may all be included in the update related to processing of tasks and in the update of the recursive work processing object.

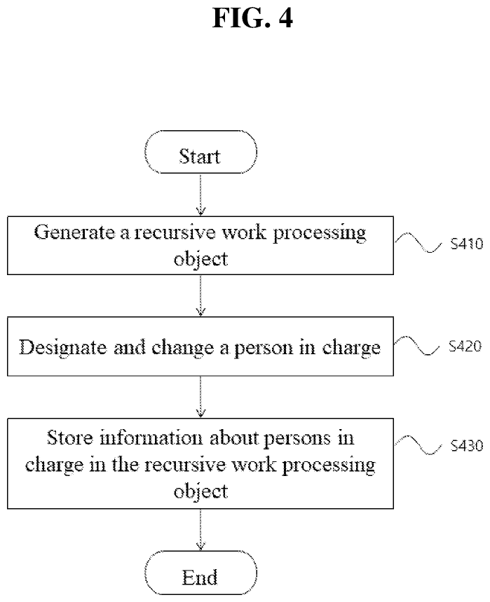

FIG. 4 is a flow chart illustrating a work processing method according to one embodiment of the present disclosure.

The work processing apparatus 110 generates a recursive work processing object from an initial setting or at the request of a work generator S410. To generate a recursive work processing object, information about a start date or a deadline of a work schedule, information about work participants who are users participating in a work, information about tasks to be processed within the work schedule, and the like may be entered.

And the work processing apparatus 110 may designate a person in charge of a recursive work processing object and also change the person in charge in accordance with a change of a task S420. A person in charge of each task may be determined all at once or sequentially by a work generator, or each person in charge may select, designate, or change a person in charge of the next task based on proper rights given.

And the work processing apparatus 110 may store change information of tasks and/or information about persons in charge, information about a change history of the persons in charge, information about a period designated for each person in charge, and the like in the recursive work processing object according to the progress of a work S430.

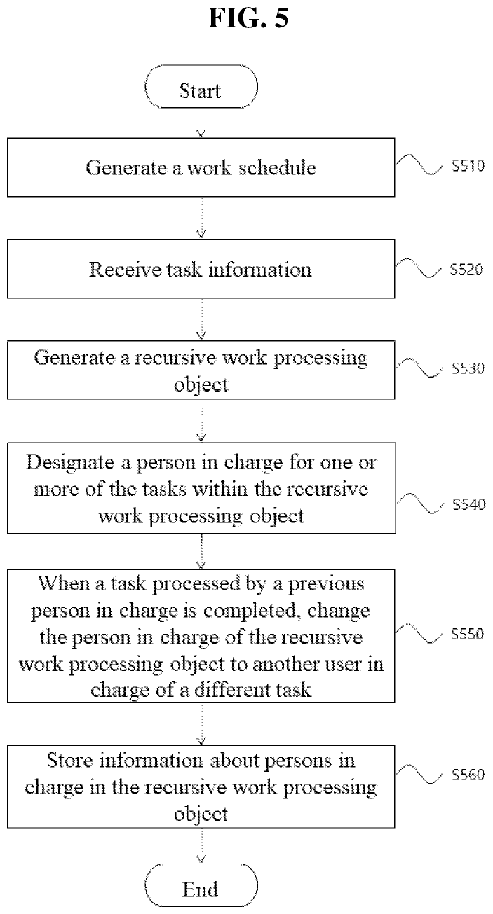

FIG. 5 is a signal flow diagram illustrating a work processing method according to another embodiment of the present disclosure.

The work processing apparatus 110 may generate a work schedule based on information about one or both of a start date and a deadline of the work schedule S510. Here, information about work participants participating in a work to be executed within the work schedule may also be included in the work schedule. In other words, when work participants are set differently for each work schedule, information about work participants may be additionally included in the work schedule.

And the work processing apparatus 110 may receive information about one or more tasks to be processed within the work schedule from a work generator S520. Information about tasks may include one or more pieces of information about a name of each task, specifics of the task, users to participate in the corresponding task, a person in charge of the task, a deadline of the task, and so on.

In one embodiment, specifics of a task may be entered by a work generator. Or, in another embodiment, specifics of the next task may be entered by a person in charge of a current task. In other words, when a work generator or a user included as a work participant designate a person in charge, the person designating a person in charge may write specifics of the next task. Therefore, the work processing apparatus 110 receives the specifics of a task to be processed by the next person in charge from the work generator or the user who designates a person in charge.

Or, the work generator may write the specifics of the next task and designate a person in charge of the corresponding task each time a task is completed. Or, the work generator may additionally write only the name and the specifics of a processed task but may not change the person in charge.

And the work processing apparatus 110 may generate a recursive work processing object including one or more tasks S530. The recursive work processing object may include information about work participants including a work processor, a person in charge, and a work generator about a work to be executed within a work schedule, namely, about one or more tasks and information about a period for processing each task and a person in charge of the task; and encapsulate the information as one object.

The work processing apparatus 110 may designate a person in charge for one or more tasks based on the information about a person in charge of each task S540. In this case, when the time to proceed with the corresponding task comes, a person in charge of a recursive work processing object is changed to the person in charge of the corresponding task.

And when a task currently being processed is completed, a person in charge of the recursive work processing object may be changed to another user who will be in charge of the next task S550.

Specifics of a task to be processed, information about a person in charge of each task, and information about a change history of persons in charge of a recursive work processing object according to the progress of a task may be stored in the recursive work processing object S560. In other words, procedures of processing a task and a processing result thereof are stored in a recursive work processing object, where information about a person in charge of each task, a processing result of a task for each person in charge, and various forms of file objects such as text, voice data, an image, or a video as processing results of a task, or file paths may be stored in the recursive work processing object; and confirmation of a processing result of a task by a person in charge or approval details thereof may also be stored in the recursive work processing object.

And the recursive work processing object may be encapsulated again by adding the corresponding updated information therein in real-time.

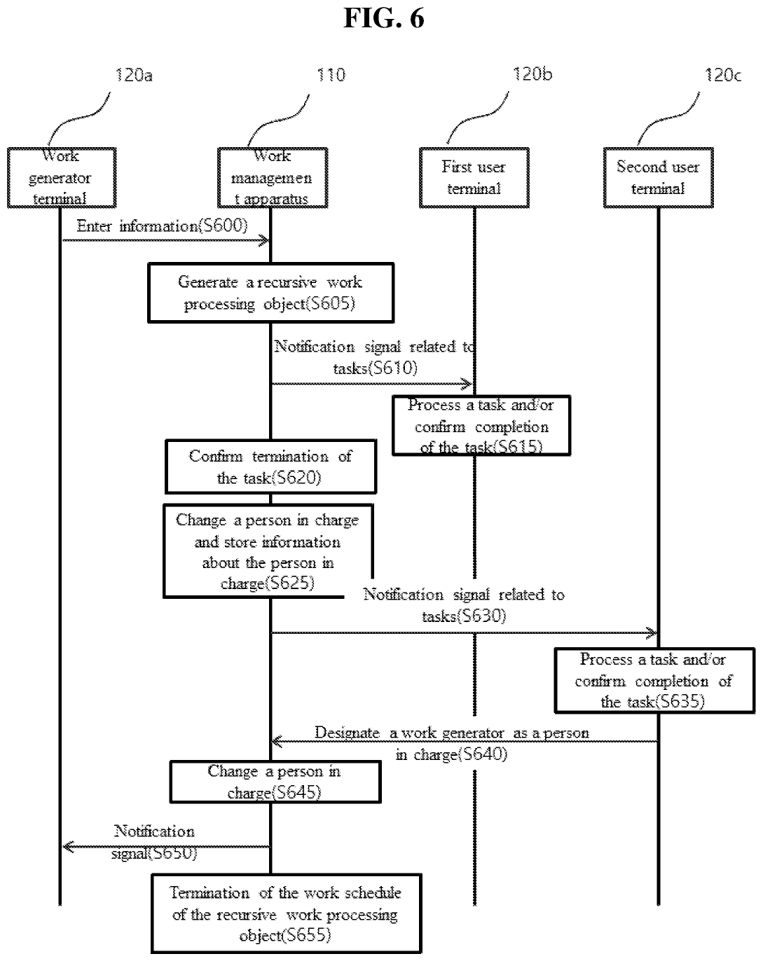

FIG. 6 is a signal flow diagram illustrating a work processing method performed in a work processing system including a work processing apparatus 110 according to an embodiment of the present disclosure.

The work generator terminal 120a may enter information required to generate a recursive work processing object into the work processing apparatus 110, S600. Since a recursive work processing object includes one or more tasks processed by one or more work participants within a work schedule, the information entered by the work generator terminal 120a may include one or more of information related to the work schedule, information about tasks, and information about work participants.

The work processing apparatus 110 may generate a recursive work processing object in response to the request of the work generator terminal 120a, S605. In other words, the work processing apparatus 110 generates a recursive work processing object according to the request of a work generator, the recursive work processing object including specifics of one or more tasks to be processed within a work schedule, where the tasks involve one or more users and include information about one or both of a start date and a deadline of the work schedule.

At this time, it is assumed that a person in charge of a task executed through a recursive work processing object is a first user. Therefore, when a work schedule is initiated and a task is proceeding, the first user is set as a person in charge of the corresponding recursive work processing object. The work generator may designate a person in charge.

In other words, the work processing apparatus 110 may receive, from the work generator terminal 120a, a user signal to designate the first user as a person in charge of a recursive work processing object. And the work processing apparatus 110 may also receive a user signal to designate a second user as the next person in charge subsequent to the first user.

Here, a user signal to designate the second user as a person in charge may be received from the work generator terminal 120a or the first user terminal 120b. It is also possible in another embodiment that a user signal to designate a person in charge may be received from a third user having rights to designate a person in charge.

And there is no limit to the time when the second user is designated as a person in charge, including the time of generating a recursive work processing object, the time of generating a task, and the time when a period ends, during which the first user is designated as a person in charge. When the first user is designated as a person in charge, a notification signal related to a task may be transmitted to the first user terminal 120b which is a terminal of the person in charge S610. The notification signal about a task of which the first user is in charge may be transmitted to the first user terminal 120b while the corresponding task is proceeding or while the first user is designated as a person in charge.

The notification signal related to a task may also be a notification signal related to a recursive work processing object including the corresponding task. Here, a notification signal may be a person-in-charge designation notification signal notifying that a specific user has been designated as a person in charge of a task; or a message received from another user or a chat message in association with a task processed or a recursive work processing object.

Also, when a task or a recursive work processing object is updated, information about the corresponding update, for example, information about who has updated which specifics, may be provided to a user as a notification signal.

And when a task is to write a note periodically or repeatedly or to update a file object such as adding, modifying, or supplementing a specific file object, in particular when the update has a period or a deadline, a reminder that notifies of an incoming update period or deadline may also be included as a notification signal.

Here, a notification signal related to a task may be transmitted through a chat room. During a period in which the first user or the second user is designated as a person in charge of a recursive work processing object, a notification signal generated in relation to the corresponding recursive work processing object is transmitted to the terminal of the person in charge. And the notification signal may be transmitted through an independent or dependent chat room of the recursive work processing object.

Here, the chat room is a chat room in which the corresponding person in charge participates and may be a dependent room coupled to a recursive work processing object or a separate chat room independent of the recursive work processing object. The work processing apparatus 110 may create a chat room in which one or more users participate and which is coupled to a recursive work processing object.

A chat room created separately from a recursive work processing object is referred to as an independent chat room for the sake of convenience. The work processing apparatus 110 may create an independent chat room to which one or more users participate. An independent chat room may be created separately from a recursive work processing object or may be created before the recursive work processing object. A recursive work processing object in an embodiment of the present disclosure may be transmitted as a chat message within an independent chat room.

Also, when a notification signal related to a recursive work processing object transmitted through an independent chat room is generated, a notification signal or a message generated after the recursive work processing object is transmitted within the independent chat room may also be transmitted through the independent chat room.

An access path to an independent chat room or chat room identification information for transmission of a notification signal of a recursive work processing object may be stored in the recursive work processing object.

Also, for a user participating in the independent chat room, the number of notification signals not read out yet by the user, namely, the number of unread notification signals may be calculated and provided for each user. Here, a notification signal or a message related to a recursive work processing object may include, for example, a person-in-charge notification signal transmitted when the corresponding user is designated as a person in charge of the recursive work processing object, a chat message or an input note transmitted in relation to the recursive work processing object, and a user signal requesting checking of whether a work is completed or confirmation of a completed work.

Here, a person in charge may create a sub-group within a user group participating in a task or a recursive work processing object or an independent or dependent chat room. In other words, a sub-group and a sub-user may be created within a user group. A user included in a sub-group may be called a sub-user. In other words, a sub-user belonging to a sub-group managed by a person in charge and dependent on the corresponding person in charge may be designated among users by a user or the person in charge.

A sub-user may have additional rights for generating or writing a note related to a task currently processed by a person in charge who manages a sub-group to which the corresponding sub-user belongs.

Also, a sub-user may have additional rights for modifying or editing a note written with respect to a task currently processed by a person in charge managing a sub-group to which the corresponding sub-user belongs or by another sub-user.

Also, the work processing apparatus 110 may count the number of notification signals or messages that each user has not checked or has not read yet and provide the number of counts to each user. The number of unread notification signals may be the number of notification messages which have been transmitted through an independent chat room but not yet output through a display of the user terminal 120 or a total number of unchecked messages accumulated before the user accesses and opens the corresponding chat room.

Here, the user may include a user who is a person in charge of the corresponding recursive work processing object or a user who is a work participant other than the person in charge. In an embodiment of the present disclosure, the number of unread notification signals provided to a person in charge and the number of unread notification signals provided to a user other than the person in charge may be provided by displaying at least one or more of color, size, font, and brightness differently.

Therefore, according to a display format in which the number of unread notification signals is provided, the user may intuitively recognize whether accumulated unchecked messages are related to a task of which the user is in charge or whether the accumulated unchecked messages are related to a task of which the user is not in charge but in which the user participates.

A person in charge and a user who is not a person in charge may have different parts in configuring various rights.

For example, a person in charge may have rights for generating or modifying a note with respect to a current task. And the remaining users except for the person in charge among the users participating in a recursive work processing object may have rights for retrieving the note that the person in charge has generated. In other words, rights for modifying or editing a note may not be allowed except for the person in charge. As described above, an ordinary user or a work participant other than a person in charge may have different rights from those of the person in charge even in writing or accessing a note.

Meanwhile, the work processing apparatus 110 may create a chat room associated with a recursive work processing object and dependent thereupon. Through a dependent chat room, too, users including a person in charge and work participants may participate in a chat.

The work processing apparatus 110 may generate a user interface provided through a chat room and provide the generated user interface to a user terminal. Through the user interface, the user may generate and process a recursive work processing object and input a user signal related to the recursive work processing object; and receive a notification signal or a message related to the recursive work processing object.

Here, through the user interface of the corresponding recursive work processing object, the work processing apparatus 110 may receive a user signal for generating a recursive work processing object from a work generator. Here, a recursive work processing object may be generated by a user interface generation request signal of the user.

And in a dependent chat room, too, a recursive work processing object may be transmitted as one of chat messages. In this case, a user participating in the corresponding dependent chat room may also be configured as participating in the recursive work processing object. In other words, according to whether a user participates in a dependent chat room, access rights to a recursive work processing object may be controlled, and a work participant of the recursive work processing object may be allowed for access rights to the dependent chat room.

The work processing apparatus 110 may count the number of notification signals unread yet by each user and provide the number of unread notification signals to each of the users participating in the dependent chat room. At this time, the work processing apparatus 110 may display the number of unread notification signals provided to a person in charge and the number of unread notification signals provided to a user other than the corresponding person in charge by varying at least one or more of color, size, font, and brightness differently.

Afterwards, a task of which the first user is in charge may be processed properly in response to specific instructions by at least part of the first user and/or other work participants; and the first user terminal 120b may confirm that the task has been processed or completed S615.

According as the first user terminals confirms or approves, the corresponding task may be terminated, and the work processing apparatus 110 may recognize termination of the corresponding task S620. And the next task within a work schedule is initiated, and the person in charge of a recursive work processing object is also changed in response to a change of the task.

In an embodiment described with reference to FIG. 6, the person in charge is changed to the second user. When a task of which the first user is in charge is completed, the work processing apparatus 110 may change the person in charge to the second user designated to take charge of another task among the users.

In other words, as the first task is terminated, the work generator or the first user may set so as to designate a second user as a second person in charge of the recursive work processing object.

When a task of which the first user is in charge is completed, the work processing apparatus 110 may change the person in charge of the recursive work processing object from the first user to the second user. At this time, when the task of which the first user is in charge is completed, a user signal notifying of completion of the corresponding task may be received from the first user. Or, when the task of which the first user is in charge is completed, a user signal requesting change of the person in charge may be received from the first user. In this case, the work processing apparatus 110 may change the person in charge of the recursive work processing object in response to the user signal of the first user.

And when the person in charge of the recursive work processing object is changed, the work processing apparatus 110 may transmit a person-in-charge designation notification signal to the second user who is a newly designated person in charge.

And the work processing apparatus 110 may store the changed information about a person in charge to the recursive work processing object S625.

When the second task of the recursive work processing object is initiated and the person in charge is changed to the second user, a notification signal related to the corresponding task may be transmitted to the second user terminal 120c, S630.

The second user, who is a person in charge of the second task within a work schedule, may process the corresponding task, confirm the processing result of a task processed by at least part of the second user and/or other work participants, and confirm that the second task has been completed S635.

And if the second task is fully completed and there is no further task to be processed, the second user may request to designate the work generator as a person in charge, and according to a configuration or the request, the work generator is designated as a new person in charge S640.

When the work generator is designated again as a person in charge of the recursive work processing object after the first user is designated as the person in charge, the work processing apparatus 110 may terminate the work schedule of the recursive work processing object. However, depending on an embodiment, from the time of designating the work generator as a person in charge until actual termination of the work schedule, a process for confirming or evaluating tasks by the work generator may be added.

The work processing apparatus 110 may store change of a person in charge, information about persons in charge of the respective tasks, or updated details about processing results of the tasks in the recursive work processing object S645.

The work processing apparatus 110 may inform that the work generator has been designated again as a person in charge of the corresponding recursive work processing apparatus or processing of tasks has been fully completed S650. After confirmation by the work generator, the work schedule of the recursive work processing object may be terminated S655.

In other words, when the work generator is designated as a person in charge of a recursive work processing object after the first user is designated as a person in charge since generation of the recursive work processing object according to the request of the work generator and initiation of a work schedule, the work processing apparatus 110 may receive, from the work generator terminal 120a, a user signal for determining whether to finally terminate the work schedule of the recursive work processing object. When a user signal for terminating the work schedule is received from the work generator terminal 120a, the work processing apparatus 110 may finally terminate the work schedule.

On the other hand, when the work schedule is not terminated, that is, when a user signal notifying of proceeding further without terminating a work is received from the work generator terminal 120a or when a user signal notifying of terminating a work is not received, the work processing apparatus 110 may not terminate the work schedule.

In this case, the work generator may again designate the next person in charge so that other tasks may be executed further, delay termination of the work, and extend work duration.

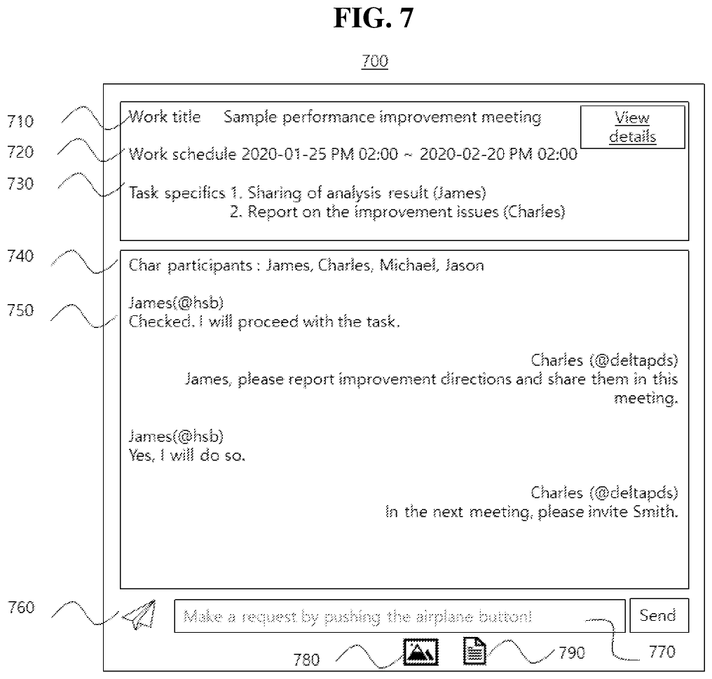

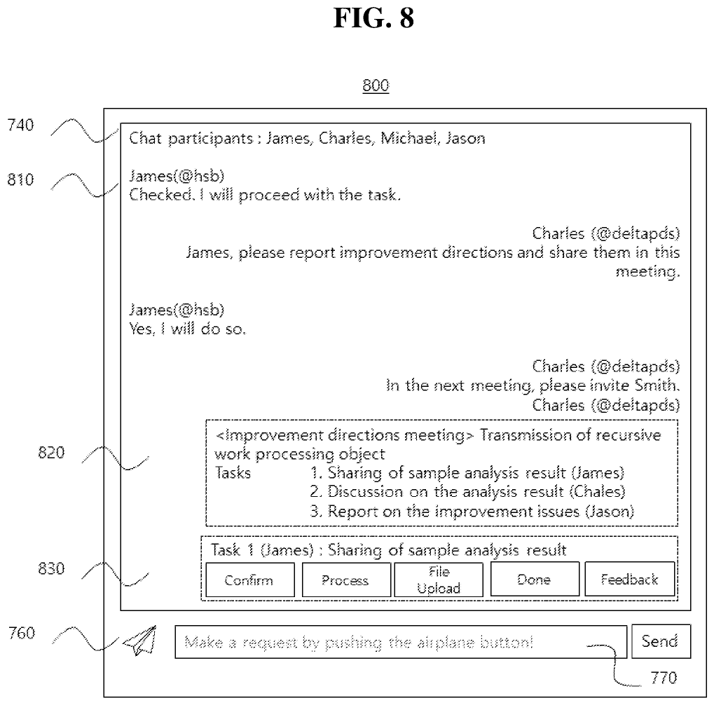

FIGS. 7 and 8 illustrate a recursive work processing object provided through a chat room 700, 800 according to an embodiment of the present disclosure.

Referring to FIG. 7, a dependent chat room created in association with a recursive work processing object is shown. Therefore, the chat room 700 may be a chat room dependent on a recursive work processing object. In the chat room of FIG. 7, specifics of a recursive work processing object, namely, the name of the whole work to be processed according to a generated work schedule 710, a work schedule 720, and specifics of one or more tasks 730 to be processed within the corresponding work schedule, may be displayed at the top of the chat room 700.

In the dependent chat room 700, a list 740 of work participants of the recursive work processing object may also be displayed together. The work participants of the recursive work processing object may have the same rights as chat participants even in the dependent chat room.

Chat messages 750 may be transmitted through the chat room 700, and until the chat messages are read out by a user, the chat messages are counted as unchecked messages when the number of unread messages is calculated. In this case, the number of unread messages displayed for a person in charge of a recursive work processing object, who is processing a current task, and the number of unread messages displayed for work participants other than the person in charge and chat participants may be displayed by using a different font, highlighting, and color.

In addition, the chat room 700 may provide a function of entering a chat message through a message input window 770 and generating a task on the chat room through a task generation button 760. Also, a user may receive, through the chat room, other interfaces 780, 790 for transmitting or retrieving an image or a document file related to a recursive work processing object or tasks included therein.

Referring to FIG. 8, an independent chat room 800 created independently of a recursive work processing object is shown.

In the independent chat room 800, too, a list 740 of work participants of a recursive work processing object may be displayed together. In this case, chat participants in the independent chat room to which a recursive work processing object is transmitted may have the same rights as the work participants of the corresponding recursive work processing object.

Chat messages 810 may be transmitted through the chat room 800, and until the chat messages are read out by a user, the chat messages are counted as unchecked messages when the number of unread messages is calculated. In this case, the number of unread messages displayed for a person in charge of a recursive work processing object, who is processing a current task, and the number of unread messages displayed for work participants other than the person in charge and chat participants may be displayed by using a different font, highlighting, and color.

In the chat room 800 of FIG. 8, a recursive work processing object 820 may be transmitted as a single chat message, and information related to the recursive work processing object such as specifics of one or more tasks to be processed within the corresponding work schedule may be displayed as a chat message.

And for the convenience of proceeding a work through a recursive work processing object, a user interface 830 dedicated to the recursive work processing object may be provided through the chat room 800. Through the user interface 830, work participants may confirm or retrieve a processing result of a task or enter a user signal through the user interface 830 to process instructed details.

Also, through the user interface 830, a file may be uploaded, or a user signal notifying of completion of the corresponding task may be entered through a done button when processing or execution of a task is completed. Also, when specifics of a task instructed through a note or a chat message are to be executed or feedback on the execution is to be entered, the user interface 830 may be utilized.

In addition, it is obvious that the independent chat room 800 may provide a function of entering a chat message through the message input window 770 and generating a task on the chat room through the task generation button 760.

Although the present disclosure has been described with reference to preferred embodiments given above, it should be understood by those skilled in the art that various modifications and variations of the present disclosure may be made without departing from the technical principles and scope specified by the appended claims below.

The disclosed technology may provide the following effects. However, since it is not meant that a specific embodiment has to provide all of the following effects or only the effects, the technical scope of the present disclosure should not be regarded as being limited by the specific embodiment.

According to the present disclosure, when two or more users are involved together in a work through a shared file or a shared folder or when multiple persons in charge process two or more sub-works to process one higher level work, the next work may be continued to be executed after one sub-work is processed and confirmed. In particular, according to an embodiment of the present disclosure, two or more users may process two or more sub-works by repeating processing and approval of the two or more sub-works within one object. And when sub-works are all processed and the initial indicator is called, it is determined that a higher work including sub-works has been completed finally and progress of the work may be terminated.

Also, according to an embodiment of the present disclosure, when a person in charge of a sub-work is changed, a notification or a message about the corresponding sub-work is provided to a relevant user designated as a person in charge in a current assignment.

In an embodiment of the present disclosure, a sub-work may be referred to as a task, and an object including multiple tasks for which persons in charge are changed may be referred to as a recursive work processing task.

Also, in an embodiment of the present disclosure, a recursive work processing object is capable of creating an associated chat room, and a notification or a message related to the corresponding recursive work processing object may be transmitted through the corresponding chat room. In other words, in an embodiment of the present disclosure, a user communication channel dedicated to the corresponding recursive work processing object is provided.

Also, since a recursive work processing object is obtained as an object by compressing information about two or more tasks, persons in charge, and so on, it is possible to transmit the recursive work processing object as one chat message within the chat room. According to an embodiment of the present disclosure, when various notifications related to chat messages and recursive work processing objects are accumulated through a chat room, an accumulated number of unread notifications may be counted and provided to the user.

Also, according to an embodiment of the present disclosure, a user interface for entering or displaying processing of tasks through a recursive work processing object, checking and evaluation of processed tasks, and feedback on the processed tasks is provided, and thereby, a user may have convenience of figuring out task status.

Also, since the present disclosure has a structure in which a work circulates within a group in charge and is recalled or returned again to the original work generator, subsequent processing or evaluation of the corresponding work may be entered without delay.

What is claimed is:

1. A work processing apparatus showing one or more tasks, comprising:
a memory; and
a processor connected electrically to the memory, the processor being configured to:
involve one or more users; include information about one or both of a start date and a deadline of a work schedule; generate a recursive work processing object including specifics of the one or more tasks to be executed within the work schedule according to a request of a work generator;
designate a first user out of the users as a person in charge of the recursive work processing object according to designation by the work generator; if the one task processed by the first user as the person in charge is completed, change a second user out of the users designated to undertake another task as the person in charge; and
store information about the person in charge for each task in the recursive work processing object.

2. The apparatus of claim 1, wherein the processor is configured to transmit a notification signal generated in association with the recursive work processing object to the person in charge during a period for which the person in charge is designated as the person in charge of the recursive work processing object.

3. The apparatus of claim 2, wherein the processor is configured to create a chat room in which one or more users participate and which are associated with the recursive work processing object; and
to transmit the notification signal through the chat room.

4. The apparatus of claim 3, wherein the processor is configured to count the number of notification signals unread yet by each user and provide the number of unread notification signals to each of the users participating in the chat room, wherein the number of unread notification signals provided to the person in charge and the number of unread notification signals provided to the user other than the person in charge are displayed by varying at least one or more of color, size, font, and brightness differently.

5. The apparatus of claim 2, wherein the processor is configured to create a chat room in which one or more users participate, wherein the chat room is created separately from the recursive work processing object, and the recursive work processing object is transmitted as a chat message in the chat room.

6. The apparatus of claim 5, wherein the notification signal generated after the recursive work processing object is transmitted within the chat room is transmitted through the chat room.

7. The apparatus of claim 1, wherein the person in charge has rights for generating or modifying a note with respect to the current task of the person in charge, and the user except for the person in charge among the users participating in the recursive work processing object has rights for retrieving the note that the person in charge has generated.

8. The apparatus of claim 1, wherein the processor is configured to generate a chat room to which one or more users participate,
provide a work processing object user interface for one or more of generation, processing of the recursive work processing object, and inputting and outputting of a user signal related to the recursive work processing object through the chat room,
receive the user signal for generation of the recursive work processing object from the work generator through the work processing object user interface, and
generate the recursive work processing object in response to the user signal.

9. The apparatus of claim 8, wherein, when the recursive work processing object is transmitted as one of chat messages through the chat room, the user participating in the chat room also participates in the recursive work processing object.

10. The apparatus of claim 1, wherein, when there is a sub-user among the users, who belongs to a sub-group managed by the person in charge and depends on the person in charge, the sub-user has further rights for creating or modifying the note with respect to the current task of the person in charge.

11. The apparatus of claim 1, wherein, when the task of which the first user is in charge is completed, the processor is configured to notify of completion of the task, receive a user signal requesting change of the person in charge from the first user, and change the person in charge of the recursive work processing object to the second user in response to the user signal.

12. The apparatus of claim 11, wherein the processor is configured to transmit a person-in-charge designation notification signal to the second user designated as the person in charge of the recursive work processing object.

13. The apparatus of claim 1, wherein the processor is configured to store user information about one or more candidate users to be designated as the person in charge and provide the user information when the work generator or one or more of the users designate the person in charge.

14. The apparatus of claim 1, wherein, depending on whether the user is designated as the person in charge or whether the user is involved in the recursive work processing object, the processor is configured to determine rights for the user to access the task or the recursive work processing object.

15. The apparatus of claim 1, wherein, when the work generator is designated as the person in charge of the recursive work processing object after the first user is designated as the person in charge, the processor is configured to terminate the work schedule of the recursive work processing object.

16. The apparatus of claim 1, wherein, when the work generator or one or more of the users designate the person in charge, the processor is configured to receive specifics of the task to be executed by the next person in charge from the work generator or the user who designates the person in charge.

17. The apparatus of claim 1, wherein the processor is configured to receive, from the work generator, a user signal for designating the persons in charge of two or more recursive work processing objects including the first user and the second user.

18. The apparatus of claim 17, wherein, when the first user and the second user are designated as the persons in charge and the user signal designating a third user as a person in charge is received from the work generator before the task of which the second user is in charge is initiated, the processor is configured to designate the third user as the person in charge of the recursive work processing object before the second user.

19. A work processing apparatus showing one or more tasks, comprising:
a memory; and
a processor connected electrically to the memory, the processor being configured to:
involve one or more users; include information about one or both of a start date and a deadline of a work schedule; generate a recursive work processing object including specifics of the one or more tasks to be executed within the work schedule according to a request of a work generator;
designate a first user out of the users as a person in charge of the recursive work processing object according to designation by the work generator; if the one task processed by the first user as the person in charge is completed, change a second user out of the users designated to undertake another task as the person in charge; and
transmit a notification signal generated in association with the recursive work processing object to the person in charge during a period for which the person in charge is designated as the person in charge of the recursive work processing object.

20. A work processing method showing one or more tasks and being performed by a memory and a processor connected electrically to the memory, the method comprising:
involving one or more users; including information about a start date and a deadline of a work schedule; generating the recursive work processing object including specifics of the one or more tasks to be executed within the work schedule according to a request of a work generator;
designating a first user out of the users as a person in charge of the recursive work processing object according to designation by the work generator; if the task processed by the first user is completed, changing a second user designated out of the users as the person in charge; and
storing information about the person in charge for each task in the recursive work processing object.
